(19) United States
(12) Patent Application Publication
(10) Pub. No.: US 2007/0137759 A1
(43) Pub. Date: Jun. 21, 2007

(54) Motor vehicle pneumatic tires and method for the production thereof

(75) Inventors: Wolfgang Roppitsch, Hannover (DE); Roland Jenke, Hademstorf (DE); Axel Neumann, Hohnhorst (DE); Joern Seevers, Burgdorf (DE)

Correspondence Address: GREENBLUM & BERNSTEIN, P.L.C., 1950 ROLAND CLARKE PLACE, RESTON, VA, 20191, US

(73) Assignee: Continental Aktiengesellschaft, Hannover (DE)

(21) Appl. No.: 10/589,984

(22) PCT Filed: Dec. 20, 2004
(86) PCT No.: PCT/EP04/53599

§ 371 Date: Aug. 18, 2006

(30) Foreign Application Priority Data
Feb. 20, 2004 (DE) 10 2004 008 308.8

(51) Int. Cl. B60C 15/00

(52) U.S. Cl. 152/555; 152/539; 156/117

(57) ABSTRACT

A vehicle pneumatic tire, including a radial ply casing, two sidewalls, two bead areas with bead cores and core profiles, and two bead reinforcements comprising tire cords. Additionally, the two bead areas are reinforced in a circumferential direction of the vehicle pneumatic tire with the two bead reinforcements. Furthermore, the tire cords are arranged directly in the bead areas without any embedding into a rubber strip.

### CROSS REFERENCE TO RELATED APPLICATIONS

The present application is a U.S. National Stage Application of International Application No. PCT/EP2004/053599 filed Dec. 20, 2004, which published as WO 2005/090100 A1 Sep. 29, 2005, the disclosure of which is expressly incorporated by reference herein in its entirety. Further, the present application claims priority under 35 U.S.C. §119 and §365 of German Application No. 10 2004 008 308.8 filed Feb. 20, 2004.

### BACKGROUND OF THE INVENTION

1. Field of the Invention

The invention relates to a vehicle pneumatic tire comprising a radial ply casing, two sidewalls and two bead areas with bead cores as well as core profiles, whereby the bead area is reinforced in the circumferential direction of the vehicle pneumatic tire with a bead reinforcement made of tire cords. The invention further relates to a method for the production of a vehicle pneumatic tire of this type.

2. Description of Background Information

Bead reinforcements in the bead areas of vehicle pneumatic tires serve, among other things, to prevent any occurrences of detachment of the turned-up end sections of the casing, given the higher stress in these areas during vehicle operation.

A vehicle pneumatic tire of the above type is known from DE 32 34 889 A1. The bead reinforcement provided in each bead area comprises several adjacent cross-laid layers of inextensible textile reinforcing members that extend at an angle of 15° to 50° to the tire circumferential direction. All bead-reinforcing plies are arranged on the outside of the radial ply casing. In one of the embodiments, the bead reinforcement is made of three fabric plies, the axially outermost of which is guided completely around the bead core.

It is known from U.S. Pat. No. 4,852,626 A to arrange a bead-reinforcing ply comprising steel cords embedded in a rubber strip between a core profile extending radially outside the bead cores and the area of the casing ply coming from the belt.

In customary tire production, the bead reinforcement comprises a rubber strip in which tire cords are arranged in a parallel manner. A bead reinforcement of this type is wound onto the tire to be produced in the respective places on the tire building drum, whereby a discontinuity in the form of a gap inevitably occurs at the transition site of the two rubber strip ends. This so-called splice at the transition site entails an inhomogeneity in the strength behavior of the pneumatic tire, as the course of the tire cords is interrupted at the transition site. In the vehicle operation of the pneumatic tire this splice causes an inhomogeneity that can impair in particular the concentricity of the tire.

### SUMMARY OF THE INVENTION

The aim of the invention is thus, on the one hand, to find a construction of the bead reinforcement that is as simple as possible and optimizes the driving properties of the pneumatic tire and, on the other hand, to simplify the manufacture of the tire.

According to the invention, a vehicle pneumatic tire includes two bead areas and a bead reinforcement made of tire cords, wherein the tire cords are arranged directly in the bead area without any embedding into a rubber strip. Additionally, according to the invention, a method for producing a pneumatic tire includes providing an annular core profile having a bead core, winding a wire-shaped tire cord to form a bead reinforcement, arranging the core profile having the bead core and the bead reinforcement on a conventional tire building drum, and completing the pneumatic tire according to a conventional tire construction process.

An advantage of the bead reinforcement according to the invention is to be seen in particular in that the bead reinforcement can now do without a splice or an abrupt transition site. The method for producing a pneumatic tire according to the invention makes it possible to directly wind the tire cord onto the core profile. Tire production as a whole can thus be rationalized, as the procedural step of placing the bead reinforcement on the tire building drum is dispensed with. Since the bead reinforcement in the tire no longer has a splice, the concentricity of the tire is more homogeneous. This considerably improves the driving properties of the tire.

In an advantageous further development of the invention it is provided that the tire cord lies against the core profile in the form of a wound spiral. This form of winding on the core profile can be realized in a simple manner. Furthermore, a bead reinforcement with a high homogeneity is thus achieved.

In another advantageous further development of the invention it is provided that the gradient angle of the spiral is smaller in the radially inner area than in the radially outer area of the spiral. The bead reinforcement can thus be adapted to the different stresses in the bead area.

In another advantageous further development of the invention it is provided that the tire cord lies against the core profile in the form of wound ellipses. The elliptical winding offers advantages during manufacture and increases the strength behavior of the bead reinforcement.

In another advantageous further development of the invention it is provided that the tire cord lies against the core profile in the form of a wound reel. The reel-like winding offers advantages during the manufacture of the bead reinforcement and may improve the driving properties of individual tire types.

In another advantageous further development of the invention it is provided that the tire cord lies against the core profile in a discontinuous manner in individual tire cord sections. This type of realization of the bead reinforcement causes an improvement of the driving properties with special tire types.

In another advantageous further development of the invention it is provided that the tire cord sections are arranged on the core profile with regularly arranged gaps. Since the gaps are arranged regularly overall, the concentricity of the pneumatic tire is not impaired.

In another advantageous further development of the invention it is provided that the tire cord sections are arranged on the core profile overlapping at the transitions. Overall, the regular overlapping of the tire cord sections causes an equalization, as a result of which the concentricity of the tire is not impaired.

In another advantageous further development of the invention it is provided that the tire cord is arranged on a fiber-reinforced rubber ply. The fiber-reinforced rubber ply causes the bead area to be additionally stabilized in this area.

In another advantageous further development of the invention it is provided that the bead reinforcement is arranged in the bead area between two casing plies. This type of arrangement of the bead reinforcement causes a higher stabilization of the bead area.

The invention is to be illustrated in more detail on the basis of several exemplary embodiments. They show:

### BRIEF DESCRIPTION OF THE DRAWINGS

FIG. 1: A conventional pneumatic tire;

FIGS. 2-5: Various possible positions of the bead reinforcement according to the invention;

FIG. 6: An exemplary embodiment in which the bead reinforcement is arranged on a rubber strip;

FIG. 7: An exemplary embodiment with a bead reinforcement, in which the tire cord is wound onto the core profile in the form of a spiral;

FIG. 8: An exemplary embodiment with a bead reinforcement, in which the tire cord is wound onto the core profile in the form of ellipses;

FIG. 9: An exemplary embodiment with a bead reinforcement, in which the tire cord is wound onto the core profile in the form of a reel;

FIG. 10: An exemplary embodiment with a bead reinforcement comprising random tire cord sections;

FIG. 11: An exemplary embodiment with a bead reinforcement comprising ordered tire cord sections; and

FIG. 12: An exemplary embodiment in which the tire cord sections are arranged in an overlapping manner.

### DETAILED DESCRIPTION OF THE INVENTION

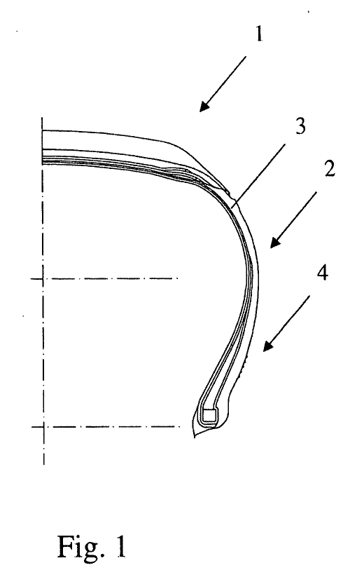

FIG. 1 shows a conventional pneumatic tire 1 with a sidewall 2, a tire casing 3 and a bead area 4, in which the bead reinforcement according to the invention is arranged.

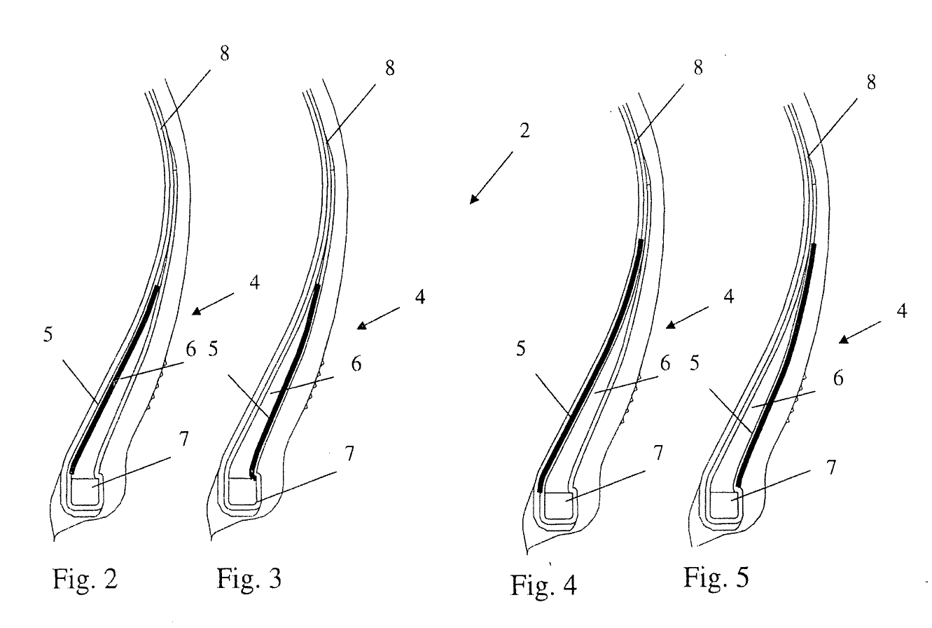

FIGS. 2 through 5 show various possible positions of the bead reinforcement 5 according to the invention. The bead reinforcement 5 comprising a wire-shaped tire cord is arranged directly on the inside of the core profile 6 in the exemplary embodiment in

FIG. 2. The core profile 6 rests on the bead core 7, whereby the tire casing 8 is guided around both components 6 and 7 in the bead area 4.

FIG. 3 shows an exemplary embodiment in which the bead reinforcement 5 lies against the outside of the core profile 6.

FIG. 4 shows an exemplary embodiment in which the bead reinforcement 5 is arranged on the inside of the core profile 6 between the two plies of the tire casing 8.

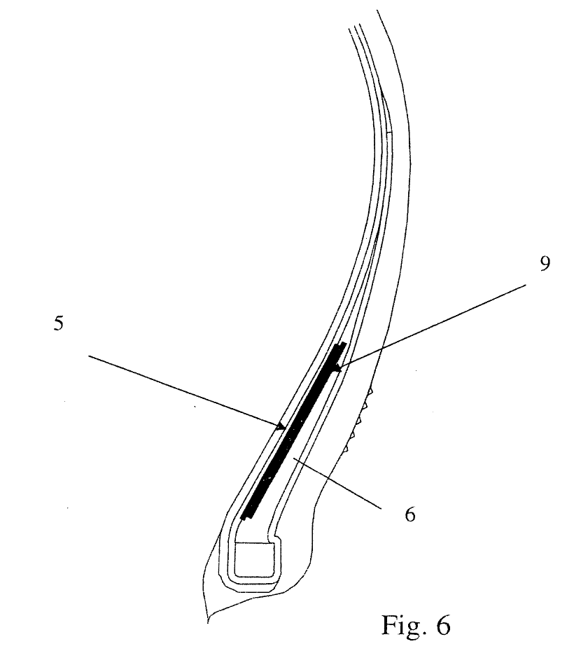

FIG. 5 shows an exemplary embodiment in which the bead reinforcement 5 is arranged on the outside of the core profile 6 and the outside of the tire casing 8.

FIG. 6 shows an exemplary embodiment with a bead reinforcement 5 arranged on a fiber-reinforced rubber strip 9 which in turn lies directly against the inside of the core profile 6.

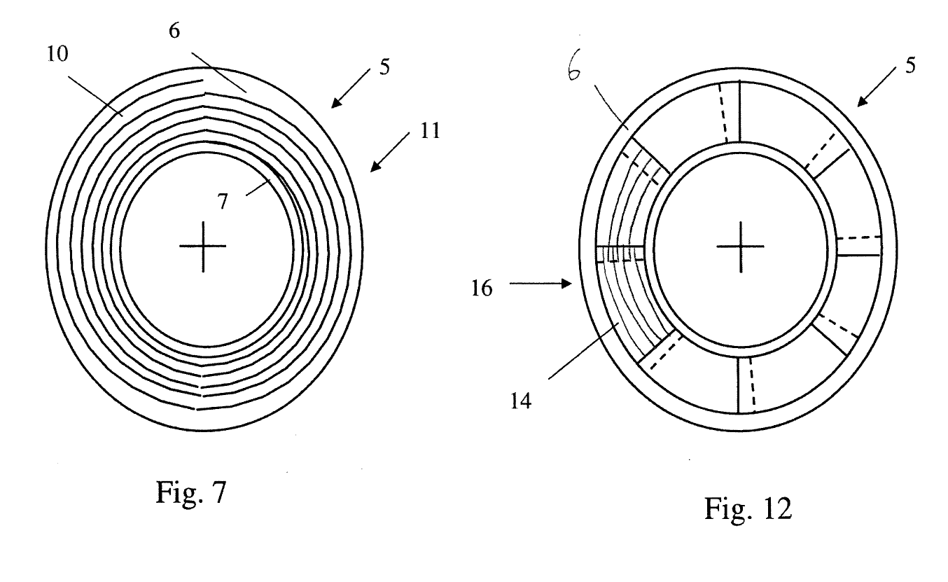

FIG. 7 shows an exemplary embodiment with a bead reinforcement 5, in which the tire cord 10 is wound onto the core profile 6 in the form of a spiral 11. This figure shows a top view of the core profile 6 that is connected to the bead core 7 on the radially inner side. The core profile 6 essentially has the form of a closed washer made of a natural-rubber material. After the assembly of the core profile 6 that is connected to the bead core 7, the winding of a wire-shaped tire cord 10 takes place. The tire cord 10 is coated with a rubber layer preferably in a coaxial manner, in order to thus increase the adhesion with the core profile 6. As the figure shows, the tire cord 10 is wound onto the core profile 6 in the form of a spiral 11. This spiral 11 as a unit forms the bead reinforcement 5. Preferably the gradient angle of the spiral 11 is thereby smaller in the radially inner area facing the bead core 7 than in the radially outer area of the spiral 11. An essential advantage of this exemplary embodiment lies in that the tire cord 10 is guided around the core profile 6 several times in a continuous manner and does not have any breaks. When the core profile 6 has been provided with the bead reinforcement 5, the compound is arranged on a conventional tire building drum, and the tire is subsequently completed in a conventional tire construction process.

FIG. 8 shows an exemplary embodiment with a bead reinforcement 5, in which the tire cord 10 is wound onto the core profile 6 in the form of ellipses 12. In this exemplary embodiment the tire cord 10 is wound onto the core profile 6 in an oval manner or in the form of ellipses 12, which gives the top view a seemingly irregular structure.

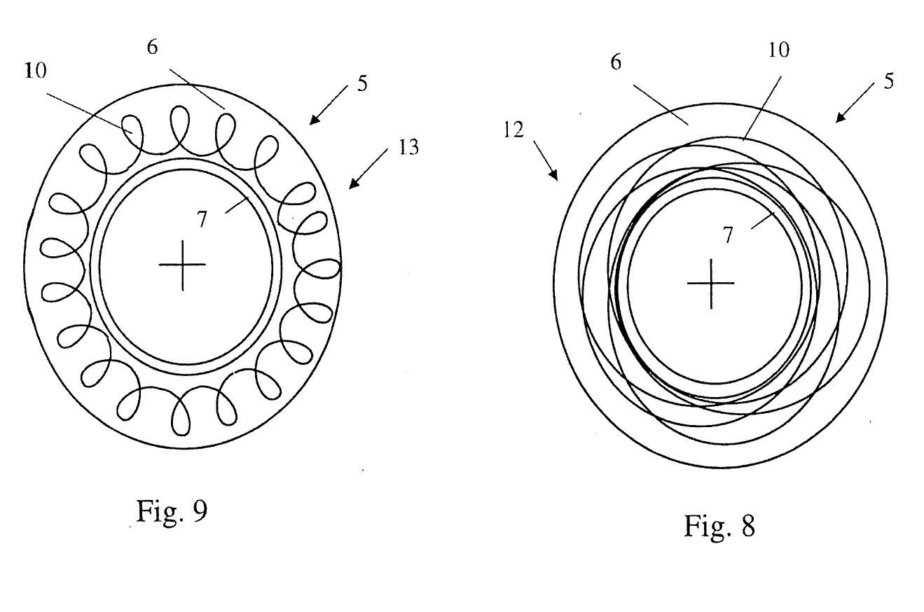

FIG. 9 shows an exemplary embodiment with a bead reinforcement 5, in which the tire cord 10 is wound onto the core profile 6 in the form of a reel 13. In this exemplary embodiment the tire cord 10 is guided around the core profile 6 in a reel-like manner.

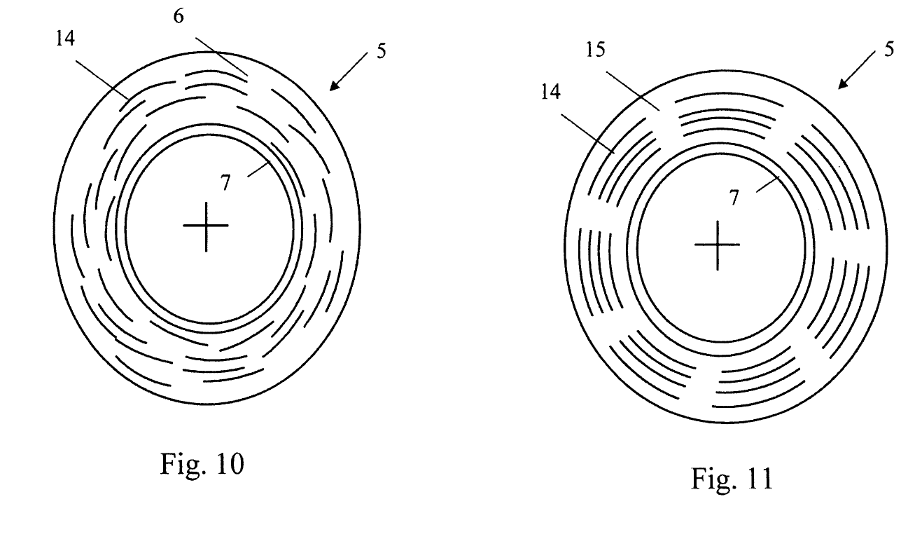

FIG. 10 shows an exemplary embodiment with a bead reinforcement 5 comprising random tire cord sections 14. The tire cord sections 14 lie against the core profile 6 individually in a random manner.

FIG. 11 shows an exemplary embodiment with a bead reinforcement 5 comprising ordered tire cord sections 14. In this exemplary embodiment the tire cord sections 14 are arranged on the core profile 6 in an ordered manner. Through this arrangement gaps 15 form on the core profile 6, in which there are no tire cord sections 14.

FIG. 12 shows an exemplary embodiment in which the tire cord sections are arranged in an overlapping manner. The tire cord sections 14 in turn are arranged in sets 16. At the transition sites between the sets 16 the tire cord sections 14 are arranged in an overlapping manner.

List of Reference Numbers

(Is Part Of The Specification)

1 Pneumatic tire
2 Sidewall
3 Tire casing
4 Bead area
5 Bead reinforcement
6 Core profile
7 Bead core
8 Tire casing
9 Fiber-reinforced rubber strip
10 Tire cord
11 Spiral
12 Ellipse
13 Reel
14 Tire cord section
15 Gap
16 Set of tire cord sections

1-11. (canceled)

12. A vehicle pneumatic tire, comprising:
a radial ply casing;
two sidewalls;
two bead areas with bead cores and core profiles; and
two bead reinforcements comprising tire cords;
wherein the two bead areas are reinforced in a circumferential direction of the vehicle pneumatic tire with the two bead reinforcements, and
wherein the tire cords are arranged directly in the bead areas without any embedding into a rubber strip.

13. The vehicle pneumatic tire according to claim 12, wherein the tire cords lie against the core profiles in the form of a wound spiral.

14. The vehicle pneumatic tire according to claim 13, wherein a gradient angle of the wound spiral is smaller in a radially inner area than in a radially outer area of the wound spiral.

15. The vehicle pneumatic tire according to claim 12, wherein the tire cords lie against the core profiles in the form of wound ellipses.

16. The vehicle pneumatic tire according to claim 12, wherein the tire cords lie against the core profiles in the form of a wound reel.

17. The vehicle pneumatic tire according to claim 12, wherein the tire cords lie against the core profiles in a discontinuous manner in individual tire cord sections.

18. The vehicle pneumatic tire according to claim 17, further comprising a core profile with regularly arranged gaps, wherein the tire cord sections are arranged on the core profile with the regularly arranged gaps.

19. The vehicle pneumatic tire according to claim 17, wherein the tire cord sections are arranged on the core profile overlapping at transitions.

20. The vehicle pneumatic tire according to claim 12, further comprising a fiber-reinforced rubber ply, wherein the tire cord is arranged on the fiber-reinforced rubber ply.

21. The vehicle pneumatic tire according to claim 12, further comprising two casing piles, wherein the bead reinforcements are arranged in the bead areas between the two casing plies.

22. A method for producing a pneumatic tire having a bead reinforcement, comprising:
providing an annular core profile having a bead core;
winding a wire-shaped tire cord to form the bead reinforcement;
arranging the core profile having the bead core and the bead reinforcement on a conventional tire building drum; and
completing assembly of the pneumatic tire according to a conventional tire construction process.
